(19) United States
(12) Patent Application Publication
(10) Pub. No.: US 2007/0031617 A1
(43) Pub. Date: Feb. 8, 2007

(54) Thermal transfer media with protective patch and adhering receptive layer and method of using the same

(75) Inventor: Gary A. Field, Portsmouth, RI (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: ZIH Corporation

(21) Appl. No.: 11/326,531

(22) Filed: Jan. 5, 2006

Related U.S. Application Data
(60) Provisional application No. 60/642,012, filed on Jan. 7, 2005.

(51) Int. Cl. B41M 5/40

(52) U.S. Cl. 428/32.51

(57) ABSTRACT

A thermal transfer media for use in printer. The thermal transfer media includes a pre-cut or preformed patch of protective film that is overlaid by a dye receptor coating. The thermal transfer media can be thermally applied to a backing media, such as a standard CR-80 card, and separated without a subsequent cutting step due to the pre-cutting of the protective film patch. Also, the dye receptor coating and pre-cut patch may share a common material composition allowing application and curing of a single layer. As another variation, the thermal print media may include adjacent pre-cut patches to allow simultaneous printing on the front and back of the backing media.

### CROSS-REFERENCE TO RELATED APPLICATIONS

This application claims the benefit of U.S. Provisional Application No. 60/642,012, filed Jan. 7, 2005, which is incorporated by reference herein in its entirety.

### BACKGROUND OF THE INVENTION

1. Field of the Invention

The present invention is related to the use of intermediate thermal transfer media and more particularly to the use of intermediate thermal transfer media in combination with a protective layer.

2. Description of Related Art

An intermediate transfer media typically includes a carrier film having a release coating supporting a receptor layer. Layered over the receptor layer (to form the outermost layer) is a permeable or semi-permeable adhesive layer, or the receptor layer has its own adhesive properties. Printing using the intermediate transfer media includes first printing on the receptor layer of the transfer media at a print station. Then, at a thermal transfer station, the thermal transfer media is adhered along the adhesive layer to a backing media, such as an identification (ID) card, by the application of heat and pressure. The carrier film is removed at the release coating revealing the printed matter of the receptor layer now supported by the backing media. An additional, laminating station may be employed to coat the combined backing media and adhered receptor layer with a transparent film.

U.S. Pat. No. 6,815,397 to Ishida et al. (“the '397 patent”) discloses an intermediate transfer medium 301 that includes a substrate film 302 and a transfer portion 306 separably supported by the substrate film, as shown in FIG. 3A of the '397 patent. The transfer portion includes a peel layer 303, an ionizing radiation-cured resin layer 304 and a receptive layer 305. Once the resin layer 304 has been adhered over the object 309, the transfer portion, including the peel layer 303, the resin layer 304 and receptor layer 305, is separated from the substrate film 302.

FIG. 3B of the '397 patent discloses a thermally transferred print formed using the intermediate transfer medium. The print 307 includes an object 309 (such as a bank or credit card) supporting the receptive layer 305 with a thermally transferred image 308, the ionizing radiation cured resin layer 304 and the release layer 303. Notably, the use of the resin layer allows transfer of the receptive layer and coating with the resin layer in a single thermal transfer step. Despite the combined use of a resin layer and intermediate transfer media provided by the '397 patent, printing using intermediate transfer media is at times troubled by reliability problems when used in various types of printers.

Therefore, it would be advantageous to have an improved thermal transfer media and method for using the same that includes both a receptor layer and a protective layer and that has robust operation.

### BRIEF SUMMARY OF THE INVENTION

The present invention addresses the above needs and achieves other advantages by providing a thermal transfer media for use in a printer. The thermal transfer media includes a pre-cut or preformed patch of protective film that is overlaid to its edges by a dye receptor coating. The thermal transfer media can be thermally applied to a backing media, such as a standard CR-80 card, and cleanly separated from its carrier film due to the pre-cutting of the protective film patch. Also, the dye receptor coating and pre-cut patch may share a common material composition allowing application and curing of a single layer. As another variation, the thermal print media may include adjacent pre-cut patches to allow simultaneous printing on the front and back of the backing media.

In one embodiment, the present invention includes an intermediate thermal transfer media for use in a printer for printing on the transfer media and transferring printed indicia from the transfer media to a backing media. A carrier sheet or film of the thermal transfer media supports a release coating, a protective preformed or pre-cut patch and a dye receptor coating. The release coating is disposed directly on the surface of the carrier film and has thermally sensitive properties that induce release (such as by a reduction in adhesiveness) with a change in temperature. The patch has protective properties, such as by being cut from a translucent or transparent polyester film, and is adhered to the release coating. The dye receptor coating extends at least partially over the surface of the patch opposite the release coating and is configured to retain ink dyes when printed thereon. Also, the dye receptor coating preferably has adhesive properties so as to adhere to the backing media when applied to the backing media. Advantageously, the pre-formed or cut patch and discrete receptive layer avoids problems with residue from the receptor coating interfering with the printer mechanism. In addition, use of the pre-cut patch negates the need for precision heating by a thermal head, allowing use of rollers or plates to effect thermal transfer.

Preferably, the pre-cut patch is sized to be slightly smaller than a typical identification card to be used as the backing media. For example, a CR-80 card has a rectangular shape with rounded edges and could be used as the backing media. In this case, the pre-cut patch would have the same shape, rectangular with rounded edges, but would be slightly smaller to accommodate error in registration of the thermal transfer media with the card. As an example, the outer edge of the pre-cut patch may be 0.030 to 0.050 inches, or even 0.1 inches short of the corresponding edges of the CR-80 card, or other backing media.

The pre-cut patch preferably is constructed of a transparent or translucent material with a smooth or matte finish. This allows visibility of the print indicia on the receptor layer through the pre-cut patch. Materials used for the pre-cut patch are preferably tough, abrasion resistant, UV protective and sufficiently thermally responsive to allow application to the backing media using heat and pressure. For example, the pre-cut patch may be constructed of a translucent polyester film with a range of thicknesses, such as 0.0005 to 0.001 inches, or even greater thicknesses such as 0.015 inches. Notably, however, the smaller thicknesses allow a roll to hold a larger number of images or combined patch and receptor layer segments.

As another option, the receptor layer is coated or mixed with an adhesive so as to allow it to adhere to the backing media when applied thereto. Preferably, the receptor layer is configured to prevent “blooming” or migration of the print indicia when heated to adhere to the backing media at temperatures in a range of 150° C. to 175° C. Further, the receptor layer material should be transparent or translucent with little or no coloration, and have a fraction of the thickness of the pre-cut patch and backing media, so as to accurately represent the ink colors of the print indicia.

In another embodiment, the carrier sheet or film of the thermal transfer media supports adjacent patch and receptor layer units that are configured to extend over the front and back of a common backing media, such as an identification card media.

In another embodiment, the thermal transfer media of the present invention includes a carrier sheet or film supporting a release coating and a dye receptor coating. The release coating is disposed directly on the surface of the carrier film and has thermally sensitive properties that induce release (such as by a reduction in adhesiveness) with a change in temperature. The dye receptor coating extends at least partially over the surface of the release coating and is configured to retain ink dyes when printed thereon. Also, the dye receptor coating preferably has adhesive properties so as to adhere to the backing media when applied thereto. Further, the dye receptor coating may be configured to form a translucent or transparent outer coating when the thermal transfer media is heated and adhered to a backing media, or otherwise cured.

The present invention has many advantages. For example, the discrete nature of the pre-formed or cut protective patch, receptive coating and release coating has the advantage of avoiding problems with residue being left behind on the carrier film and interfering with the mechanisms of the printer. In addition, use of the pre-cut or preformed protective patch negates the need for a precise thermal head to ensure close registration of the protective layer and print indicia with the backing media, allowing use of simple heated rollers or plates to effect thermal transfer. Residue from the release coating and dye receptor coating is reduced by allowing kiss-cutting and separation of the excess of these materials from the carrier film, along with the ladder of cut protective layer, during the material forming stage and before end-use in the printer.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic illustration of a printer of one embodiment of the present invention for printing using an intermediate thermal transfer media;

FIG. 2 is a side elevation view of an intermediate thermal transfer media of another embodiment of the present invention;

FIG. 3 is a side elevation view of a thermal transfer media of another embodiment of the present invention; and

FIG. 4 is a plan view of a media of a thermal transfer media of yet another embodiment of the present invention.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

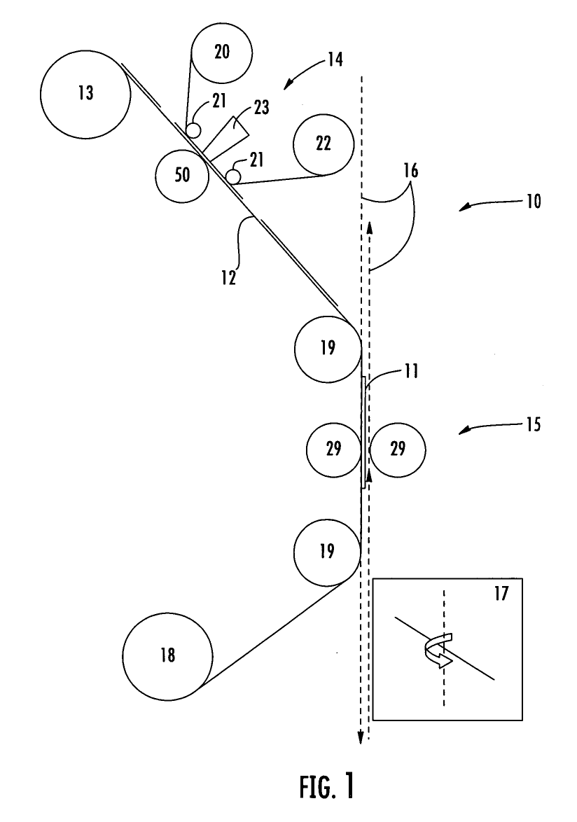

In one embodiment, the present invention includes a printer 10 for printing on media cards 11 using an intermediate thermal transfer media 12, as shown in FIG. 1. Generally, the printer 10 houses an intermediate thermal transfer media supply roll 13 that dispenses (in strip form) the intermediate thermal transfer media 12 past a dye printing station 14 where print is applied to the intermediate thermal transfer media. Further downstream, the intermediate thermal transfer media 12 extends past a thermal transfer station 15 wherein portions of the intermediate thermal transfer media bearing print are transferred onto media cards 11. The media cards follow a media card path, as shown by dashed line 16, that extends from a media card supply (not shown), through the thermal transfer station 15 to a card reversing mechanism 17, and then back through the thermal transfer station again to allow transfer onto both sides of each of the media cards 11.

The media cards 11 can be any type of backing media, such as non-standard or standard cards. For instance, CR-80 sized cards constructed of poly-vinyl chloride (PVC) may be used as the backing media. Other card standards and materials could also be used, such as CC10, CC20 and CC30 cards constructed of polyester, and still be within the scope of the present invention. In addition, although the printer 10 is illustrated as printing on the media cards 11 using the intermediate thermal transfer media 12 of the present invention, other types, shapes and materials of backing media may be employed. For example, the print may be thermally transferred onto continuous sheets of polymer, photographic paper or other materials.

Referring again to FIG. 1, the printer 10 includes the media card path 16 that extends through the card reversing mechanism 17. The card reversing mechanism 17 is configured to reorient the card so that its opposite flat, image bearing surface is facing the thermal transfer media 12 on its return trip through the thermal transfer station 15. Generally, the card reversing mechanism 17 includes any device, method or collection of devices that reorients the media cards 11. For example, the card reversing mechanism disclosed in commonly assigned U.S. patent application Ser. No. 10/807,657 entitled “Card-Flipping Device for Use in Card Printers” filed on Mar. 24, 2004 which is hereby incorporated herein by reference, could be used in the present invention.

The card reversing mechanism described in the '657 application grips the edges of the media card and rotates the card in place. However, the media card can be reversed using other mechanisms, such as by translation over a closed loop belt. Regardless, reversal of the media cards 11 facilitates a dual-surface printing capability of the intermediate thermal transfer media 12 of the present invention, as will be described in more detail below.

The supply roll 13 typically includes a rolled strip of the intermediate thermal transfer media 12 wound on a supporting core. The core is rotatably supported to play out the strip of intermediate thermal transfer media 12 in response to tension from a positively driven take-up roll 18. The supply roll 13 may also be motivated to allow back-and-forth movement of the intermediate transfer media 12, to allow printing of different colors onto the intermediate transfer media. In the exemplary embodiment of FIG. 1, the printer 10 also includes a pair of free rotating idlers 19 which are positioned adjacent the media card path 16. In its complete path, the thermal transfer media 12 extends off of the supply roll 13, through the dye printing station 14, over a first one of the idlers 19, through the thermal transfer station 15, over a second one of the idlers 19 and onto the take-up roll 18. It should be noted, however, that the storage, path of travel and motivation of the thermal transfer media could be varied. For example, the thermal transfer media could be in discrete sections, instead of a strip, and dispensed from a cartridge through the dye printing station 14 and the thermal transfer station 15.

The dye printing station 14 includes a color ribbon supply roll 20, a pair of idlers 21, a color ribbon take-up roll 22, a thermal printing head 23 and a platen roller 50. The color ribbon supply roll 20 supplies a color ribbon 24 that has, for example, a sequence of colorant panels including yellow (Y), magenta (M), cyan (C) and/or black (K) panels for imprinting of a range of colors or light/dark shades onto the intermediate thermal transfer media 12 by the thermal printing head 23. Typically, this is referred to as a dye sublimation technique for the Y, M and C panels, and/or mass transfer printing for the K panel. Of course it should be noted that other types of printing techniques could be employed as long as they are compatible with printing on the intermediate thermal transfer media 12 of the present invention.

Referring again to FIG. 1, the color ribbon 24 extends off of the color ribbon supply roll 20, over a first one of the idlers 21 until adjacent and coextensive with the intermediate thermal transfer media 12, between the thermal printing head 23 and the platen roller 50, over a second one of the idlers 21 and onto the ribbon take-up roll 22. The take-up roll 22 is preferably motivated so as to advance the color ribbon 24 during multiple printing passes and heating of the thermal printing head 23 to imprint on the intermediate thermal transfer media 12 before it is advanced to the thermal transfer station 15.

The thermal transfer station 15, as shown schematically in FIG. 1, includes a pair of thermal compression rollers 29 that are heated, such as by having a conductive film on their surface connected to a power source, and urged together to compress the thermal transfer media 12 against an adjacent one of the media cards 11. Other devices could be used in the thermal transfer station 15 to effect thermal transfer, including a pair of arcuate or flat plates that are urged together and are heated. Advantageously, as will be described below, these devices need not be complex due to the discrete prints that comprise the thermal transfer media 12.

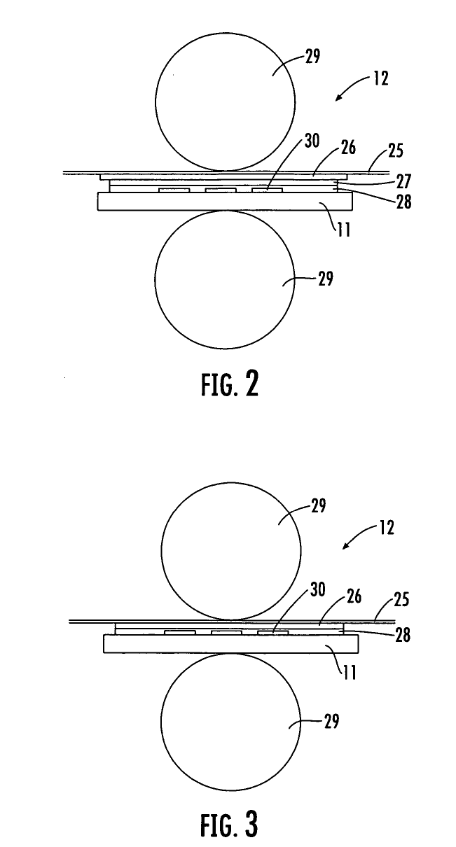

Referring now to FIG. 2, a portion of the intermediate thermal transfer media 12 of one embodiment of the present invention is shown being applied to one of the media cards 11. The intermediate thermal transfer media 12 has several layers, including (in order) a carrier film 25, a release coating 26, a protective patch 27 and a dye receptor coating 28. Positioned adjacent the dye receptor coating 28 is one of the media cards 11 which is shown in FIG. 2 as being compressed and heated to effect thermal transfer of the dye receptor coating and the protective patch 27 using the thermal compression rollers 29 of the thermal transfer station 15.

The carrier film 25 provides support for the remaining layers and is resistant to the heat of the thermal printing and thermal transfer. Preferably, the carrier film is much thinner than the media cards 11 and the protective patch 27, having a thickness of about 0.0005 inches up to 0.004 inches. This low thickness reduces the thickness of the supply roll 13. Material types employable as the carrier film 25 include, for example, tissue papers, paraffin papers, polyester films, polyethylene terephthalate films, polypropylene, cellophane and other types of films and papers. Notably, just about any type of film or paper that is relatively flexible (if necessary) and heat resistant may be employed with the present invention to support the other layers of the intermediate transfer media 12.

The release coating 26 (sometimes referred to as a peel layer) is disposed directly on the surface of the carrier film 25 between the carrier film and the protective patch 27. Preferably, the release coating has adhesive properties which adhere the carrier film and the protective patch together until subjected to the heat of thermal transfer, at which time release is induced such as by a reduction in adhesiveness. This allows the carrier film 25 to be peeled away from the protective patch 27 once the protective patch and the receptor coating 28 are adhered to one of the media cards 11.

Examples of materials used in the release coating 26 include binders, such as various waxes, low-molecular weight polyethylene, silicone resin, acrylic resin, polyurethane resin, etc., combined with release materials such as talcum powder, silica, lubricants, etc. The release coating can be applied to the carrier film 25 by liquefying the composition and printing, such as with a gravure plate, it onto carrier film 25. Notably, the width of the release coating 26 may be kept to within close tolerances (thousands or fractions of an inch) of the protective patch 27 width to further minimize debris produced during printing, thereby increasing reliability.

Referring again to FIG. 2, the protective patch 27 has a discrete width due to being either applied and cut prior to use in the printer (as will be described in more detail below) or having been cut, or pre-formed in its preferably standard shape prior to application to the release coating 26. This enables thermal transfer application of the protective patch 27 in the printer 10 at the same time as transfer of the dye receptor coating 28 without a cutting step to form the protective patch.

Materials used for the protective patch 27 are preferably tough, abrasion resistant, UV protective and sufficiently thermally responsive to allow application to the backing media using heat and pressure. Also, the pre-cut patch preferably is constructed of a transparent or translucent material with a smooth or matte finish. This allows visibility of the print indicia on the receptor layer through the pre-cut patch. For example, the pre-cut patch may be constructed of a translucent polyester film with a range of thicknesses, such as 0.0005 to 0.001 inches, or even greater thicknesses such as 0.015 inches. Notably, however, the smaller thicknesses allow a roll to hold a larger number of images or combined patch and receptor layer segments. Other materials usable for the protective film could include curable resins, such as silicone resins, or acrylates, transparent PVC, polycarbonates and materials having a varying range of crosslinking adjusted to reflect the desired toughness and flexibility for the protective patch.

Preferably, the protective patch 27 is sized to be slightly smaller than a typical identification card to be used as the backing media. For example, the CR-80 type card has a rectangular shape with rounded edges and could be used as the backing media. In this case, the protective patch would have the same shape, rectangular with rounded edges, but would be slightly smaller to accommodate error in registration of the thermal transfer media with the card. As an example, the outer edge of the pre-cut patch may be 0.030 to 0.050 inches, or even 0.1 inches short of the corresponding edges of the CR-80 card, or other backing media.

The dye receptive coating 28 extends over the surface of the protective patch 27 opposite the release coating 26 and is configured to retain ink dyes or other materials forming printed indicia 30 (such as hot melt inks) and referred to herein generally as “dyes,” as shown in FIG. 2. Also, the dye receptor coating preferably has adhesive properties so as to adhere to the backing media when heat transferred thereto. Resin materials that are receptive to thermally transferable colorants can be used to form the receptive coating 28, such as polyolefin resins, halogenated resins, vinyl resins, polyester resins, polyamide resins, polycarbonates or vinyl chloride resins. Similar to the release coating 26, these compositions, and others, may be liquefied and applied by printing or extrusion on the protective patch 27.

During printing, the intermediate transfer media 12 is advanced toward the dye printing station 14, at which point the thermal printing head 23 prints onto the dye receptor coating 28 of the adjacent portion of the transfer media including a single discrete protective patch 27 with dye receptor coating 28 extending over the patch, as shown in FIG. 2. The thermal printing head 23 and/or the intermediate transfer media 12 may be moved to form the appropriate shape, color and configuration of the printed indicia 30.

The dye receptor coating 28 bearing the printed indicia 30 is then advanced into the thermal transfer station 15 and between the thermal compression rollers 29 in approximate registration with one of the media cards 11 moving along the media card path, as shown in FIG. 1. The compression and heat of the compression rollers 29 causes the receptor coating 28 to adhere to one surface of the media card and may cause some melting and hardening adherence of the protective patch 27. Further advancement out of the thermal transfer station 15 separates the carrier film 25 at the release coating 26 so that the media card is coated on one surface by the printed indicia 30, receptor coating 28 and the protective patch 27.

The partially formed ID card is then picked up by the card reversing mechanism 17 which turns the card end-over-end so that its uncovered surface is facing the opposite way. The media card 11 is then advanced back through the thermal transfer station 15 and the process described above is repeated to adhere a second discrete printed indicia 30, receptor coating 28 and protective patch 27 combination on the other side of the card. It should be noted that each of the media cards 11 need not have dual side application, but may only have thermal transfer printing on one side. The completed ID card is then dispensed from the printer 10 in a conventional manner.

In another embodiment of the intermediate thermal transfer media 12 of the present invention, the dye receptor coating 28 contains resins allowing it to be cured into a hard protective layer similar to the protective patch 27 during compression and heating with the thermal compression rollers 29, as shown in FIG. 3.

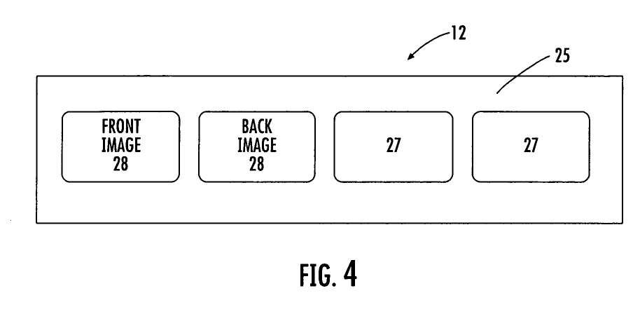

Referring to FIG. 4 and in yet another embodiment, the protective patch 27 (or patches) are supported on carrier film 25 of the same thermal transfer media adjacent discrete receptor coating 28 (or coatings) so that the receptor coatings with printed indicia 30 can be applied first and the protective patches afterwards using the thermal transfer station 15.

In another embodiment, the above-described discrete, release coating 26, protective patch 27 and receptor coating 28 units may be spaced side-by-side along the supporting carrier film allow simultaneous or sequential front and back printing on the same ID card.

In yet another embodiment, the present invention includes a process wherein a continuous layer of each of the release coating, a protective material and receptor coating are applied sequentially to the supporting carrier film. This laminate combination is then kiss cut to form the discrete patch or card shapes and the ladder of remaining excess material is separated from the supporting carrier film (resulting in the above-described discrete patch embodiments) before its use in the printer 10, thereby avoiding excess residue on printing and separate of the carrier film from the remaining components.

The present invention has many advantages. For example, the pre-formed or cut protective patch 27 has the advantage of avoiding problems with residue from the receptor coating interfering with the cutting mechanism in a printer. No precision cutting is required in the printer 10, simplifying its operation. In addition, use of the pre-cut or preformed protective patch 27 negates the need for a precise thermal head to ensure close registration a protective layer and print indicia with the backing media, allowing use of simple heated rollers or plates to effect thermal transfer. Residue from the release coating and dye receptor coating is reduced by allowing kiss-cutting and separation of the excess of these materials from the carrier film, along with the ladder of cut protective layer, before its end-use in the printer 10 or before printing.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of constructing an intermediate transfer media for use in a printer for printing on a backing media, said method comprising:
disposing a continuous layer of release coating over at least one surface of a carrier film;
disposing a continuous layer of protective film over the release coating; and
disposing a continuous layer of dye receptor coating over a surface of the discrete patch opposite the release coating to create a laminate combination;
kiss-cutting the laminate combination; and
removing a ladder of remaining excess material to create a series of discrete patches, wherein each discrete patch comprises at least the protective film and the dye receptor coating.

2. The method of claim 1, wherein each discrete patch comprises the release coating, the protective film,, and the dye receptor coating.

3. The method of claim 1, wherein said steps of kiss-cutting the laminate combination and removing a ladder of remaining excess material produces discrete shapes that are 0.030 to 0.1 inches smaller than the outer dimensions of the backing media.

4. The method of claim 1, wherein the carrier film is about 0.0005 inches to 0.004 inches in thickness.

5. The method of claim 1, wherein the carrier film is constructed of at least one of tissue papers, paraffin papers, polyester films, polyethylene terephthalate films, polypropylemne, or cellophane.

6. The method of claim 1, wherein said step of disposing a continuous layer of release coating comprises disposing a binder combined with a release material.

7. The method of claim 6, wherein the binder includes at least one of wax, low-molecular weight polyethylene, silicone resin, acrylic resin, or polyurethane resin, and the release material includes at least one of talcum powder, silica, or lubricant.

8. The method of claim 1, wherein said step of disposing a continuous layer of protective film comprises disposing at least one of translucent polyester films, curable resins, acrylates, transparent PVC, or polycarbonates.

9. The method of claim 1, wherein said step of disposing a dye receptor coating comprises disposing at least one of polyolefin resins, halogenated resins, vinyl resins, polyester resins, polyamide resins, polycarbonates, or vinyl chloride resins.

10. The method of claim 1, wherein said step of disposing a dye receptor coating and disposing a protective film are combined to comprise disposing a common material composition allowing application and curing of a single layer.

11. The method of claim 1, wherein said receptor layer includes an adhesive so as to allow it to adhere to the backing media.

12. The method of claim 1, wherein said discrete shapes are configured to extend over the front and back of the backing media.

13. An intermediate thermal transfer media for use in a printer for printing on a backing media, said thermal transfer media comprising:
a carrier film;
a release coating disposed over at least one surface of the carrier film, said release coating having thermally sensitive properties inducing release;
a discrete patch of protective film disposed over the release coating, wherein the release coating is configured to hold the discrete patch to the carrier film until heated; and
a dye receptor coating extending at least partially over a surface of the discrete patch opposite the release coating and is configured to retain ink dyes when printed thereon, said dye receptor coating having adhesive properties so as to be capable of adhering to the backing media when heated, said adherence also at least partially adhering the discrete patch.

14. The intermediate thermal transfer media of claim 13, wherein said discrete patch of protective film is sized to be smaller than the backing media.

15. The intermediate thermal transfer media of claim 13, wherein said release coating extends to, but not past, the edges of the discrete patch of protective film.

16. The intermediate thermal transfer media of claim 13, wherein said discrete patch of protective film is constructed by at least one of pre-cutting or pre-forming.

17. The intermediate thermal transfer media of claim 13, wherein the outer dimensions of said discrete patch are 0.030 to 0.1 inches smaller than the outer dimensions of the backing media.

18. The intermediate thermal transfer media of claim 13, wherein said carrier film has a thickness of about 0.0005 inches to 0.004 inches.

19. The intermediate thermal transfer media of claim 13, wherein said carrier film is constructed of at least one of tissue papers, paraffin papers, polyester films, polyethylene terephthalate films, polypropylemne, or cellophane.

20. The intermediate thermal transfer media of claim 13, wherein said release coating comprises a binder combined with a release material.

21. The intermediate thermal transfer media of claim 20, wherein said binder includes at least one of wax, low-molecular weight polyethylene, silicone resin, acrylic resin, and polyurethane resin, and said release material includes at least one of talcum powder, silica, or lubricant.

22. The intermediate thermal transfer media of claim 13, wherein said discrete patch is constructed of at least one of translucent polyester films, curable resins, acrylates, transparent PVC, or polycarbonates.

23. The intermediate thermal transfer media of claim 13, wherein said dye-receptive coating is constructed of at least one of polyolefin resins, halogenated resins, vinyl resins, polyester resins, polyamide resins, polycarbonates, or vinyl chloride resins.

24. The intermediate thermal transfer media of claim 13, wherein said dye receptor coating and said patch of protective film share a common material composition allowing application and curing of a single layer.

25. The intermediate thermal transfer media of claim 13, wherein said dye receptor coating includes an adhesive so as to allow it to adhere to the backing media.

26. The intermediate thermal transfer media of claim 13, wherein said carrier film includes multiple adjacent units comprising patches of protective film and receptor coatings.

27. The intermediate transfer media of claim 26, wherein said units are configured to extend over the front and back of the backing media.

28. An intermediate thermal transfer media for use in a printer for printing on a backing media, said thermal transfer media comprising:
a carrier film;
a release coating disposed over at least one surface of the carrier film, said release coating having thermally sensitive properties inducing release; and
a dye receptor coating configured to retain ink dyes when printed thereon, said dye receptor coating having adhesive properties so as to adhere to the backing media when heated,
wherein said dye receptor coating contains resins allowing it to be cured into a discrete protective layer when heated.

29. A method of printing on both sides of a backing media comprising:
providing a series of adjacent discrete patches of protective film and discrete receptor coatings;
reversing the backing media in a reversing mechanism after adhering a discrete dye receptor coating and discrete patch of protective film on a front of the backing media;
printing ink dyes onto a subsequent discrete receptor coating at the dye printing station;
adhering the discrete dye receptor coating to a back of the backing media at the thermal transfer station; and
adhering a subsequent discrete patch of protective film to the back of the backing media above the dye receptor coating at the thermal transfer station.
